(19) United States
(12) Patent Application Publication
(10) Pub. No.: US 2015/0370768 A1
(43) Pub. Date: Dec. 24, 2015

(54) METHODS, SYSTEMS, AND MEDIA FOR GENERATING A SUMMARY OF A DOCUMENT

(71) Applicant: The Speed Reading Group, Chamber of Commerce number: 60482605, Amsterdam (NL)

(72) Inventor: Mark Sybren Tigchelaar, Amsterdam (NL)

(21) Appl. No.: 14/493,705

(22) Filed: Sep. 23, 2014

Related U.S. Application Data
(60) Provisional application No. 62/014,555, filed on Jun. 19, 2014.

(51) Int. Cl. G06F 17/24; G06F 3/0484

(52) U.S. Cl. CPC G06F 17/24; G06F 3/04842

(57) ABSTRACT

In accordance with some embodiments of the disclosed subject of matter, mechanisms for generating a summary of a document are provided. In some embodiments, methods for generating a summary of a document are provided, the methods comprising: receiving a document to be read; generating a summary of the document using a hardware processor; presenting a plurality of sentences of the document at a set reading speed; receiving a user request to pause the presentation; and in response to the user request, highlighting a portion of a sentence within the plurality of sentences and adding the sentence to the summary.

### CROSS-REFERENCE TO RELATED APPLICATIONS

This application claims the benefit of U.S. Provisional Patent Application No. 62/014,555, filed Jun. 19, 2014, which is hereby incorporated by reference herein in its entirety.

### TECHNICAL FIELD

The disclosed subject matter relates to methods, systems, and media for generating a summary of a document.

### BACKGROUND INFORMATION

Many people read documents (e.g., articles, works of fiction, textbooks, newspapers, magazines, etc.) on a screen. However, without a summary of a document, it is not convenient to capture all of the important information of the document during a quick reading, nor easy to remember all the key points of the document after reading, especially for a complex and/or long document. Therefore, presenting a document without a summary may not be a time-effective way for a user to read.

Accordingly, it is desirable to provide new mechanisms for generating a summary of a document.

### SUMMARY

In accordance with some embodiments of the disclosed subject of matter, mechanisms for generating a summary of a document are provided. In some embodiments, methods for generating a summary of a document are provided, the methods comprising: receiving a document to be read; generating a summary of the document using a hardware processor; presenting a plurality of sentences of the document at a set reading speed; receiving a user request to pause the presentation; and in response to the user request, highlighting a portion of a sentence within the plurality of sentences and adding the sentence to the summary.

In some embodiments, a system for generating a summary of a document is provided, the system comprising: a hardware processor that is programmed to: receive a document to be read; generate a summary of the document using a hardware processor; present a plurality of sentences of the document at a set reading speed; receive a user request to pause the presentation; and in response to the user request, highlight a portion of a sentence within the plurality of sentences and add the sentence to the summary.

In some embodiments, a non-transitory computer-readable medium containing computer-executable instructions that, when executed by a processor, cause the processor to perform a method for generating a summary of a document is provided, the method comprising: receiving a document to be read; generating a summary of the document using a hardware processor; presenting a plurality of sentences of the document at a set reading speed; receiving a user request to pause the presentation; and in response to the user request, highlighting a portion of a sentence within the plurality of sentences and adding the sentence to the summary.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is an example of a system for generating a summary of a document in accordance with some embodiments of the disclosed subject matter.

FIG. 2 is an example of hardware that can be used in a server and/or a computing device in accordance with some embodiments of the disclosed subject matter.

FIG. 3 shows a flow chart of an example of a process for generating a summary of a document in accordance with some embodiments of the disclosed subject matter.

FIG. 4 shows an example of a user interface of adding a sentence to a summary of a document in accordance with some embodiments of the disclosed subject matter.

FIG. 5 shows an example of a user interface of presenting a summary of a document in accordance with some embodiments of the disclosed subject matter.

### DETAILED DESCRIPTION

In accordance with various embodiments, as described in more detail below, mechanisms, which can include methods, systems, and computer-readable media, for generating a summary of a document are provided.

In some embodiments, these methods, systems, and media can automatically generate a summary of a document being read by a user, and can automatically include important points of the document in the summary. In some embodiments, the mechanisms can determine whether a sentence within the document is to be added to the summary based on an importance evaluation of the sentence. Such an importance evaluation can be determined based on a structure analysis of the document and/or a words analysis of the sentence. For example, the mechanisms described herein can determine whether a sentence is a kernel sentence and/or a conclusion sentence of a section and/or a chapter of the document. As another example, the mechanisms described herein can determine whether a sentence contains one or more signal words and/or phrases (e.g., “important,” “essential,” “as a result,” “in summary,” etc.). As yet another example, the mechanisms described herein can determine whether a sentence contains a word or a phrase that is related to a keyword of the document, and/or whether a sentence describes an important part (e.g., a graph, an enumeration list, etc.) of the document. Based on the importance evaluation of each sentence of the document, the mechanisms described herein can automatically generate a summary of the document.

In some embodiments, the methods, systems, and media present guidance information to a user within a document being presented to the user. Such guidance information can, in some embodiments, include successively highlighting sentences or portions of sentences to encourage the user to read the text of the document by moving the path of the user's eyes from one portion highlighted by guidance information to the next. During a guided reading process of a user, when the user finds a sentence being read that is important, the mechanisms described herein can allow the user to pause the guiding to highlight the sentence and add the sentence to the summary of the document.

In some embodiments, the methods, systems, and media can format and present the generated summary to the user, and can share the summary with other users. This can allow a user to capture the most important information of the document more quickly, and/or with increased reading comprehension than if the user were to read the document without the summary being generated using the methods, systems, and media herein.

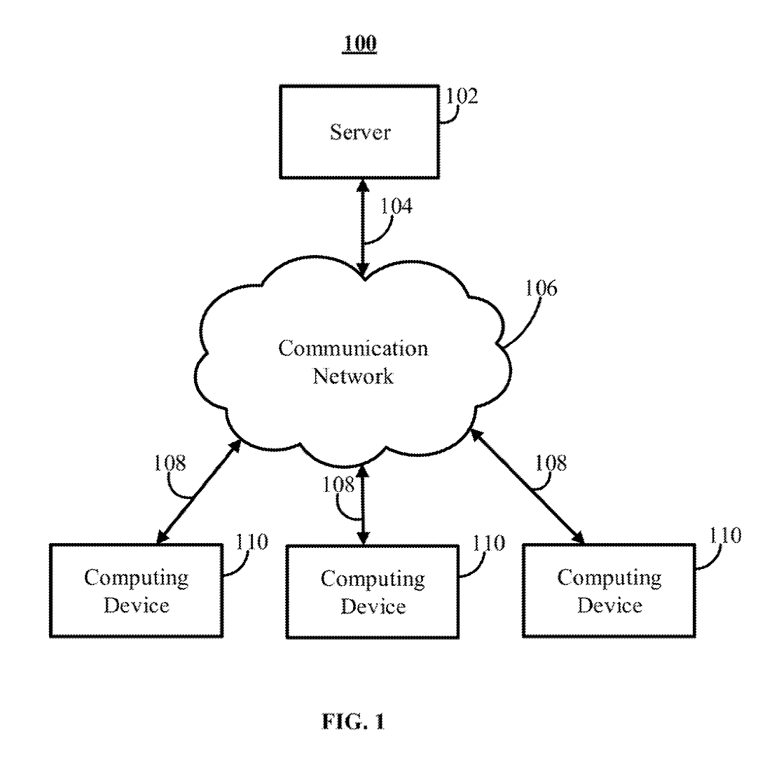

FIG. 1 shows an example of a generalized schematic diagram of a system 100 on which the mechanisms for generating a summary of a document as described herein can be implemented in accordance with some embodiments. As illustrated, system 100 can include one or more computing devices 110. Computing devices 110 can be local to each other or remote from each other. Computing devices 110 can be connected by one or more communications links 108 to a communications network 106 that can be linked via a communications link 104 to server 102.

In some embodiments, system 100 can include one or more servers 102. Server 102 can be any suitable server for providing access to the mechanisms described herein or for providing copies of an application or a portion of an application (e.g., a computer program or portion of a computer program) for utilizing the mechanisms described herein for generating a summary of a document, such as a hardware processor, a computer, a data processing device, or any suitable combination of such devices. For example, the mechanisms for generating a summary of a document can be distributed into multiple backend components and multiple frontend components and/or interfaces. In a more particular example, backend components, such as data collection, data distribution, document synchronization, etc., can be performed on one or more servers 102. In another particular example, frontend components, such as a user interface, presenting a document, adding one or more sentences to a summary, etc., can be performed on one or more computing devices 110.

In some embodiments, each of the computing devices 110 and server 102 can be any of a general purpose device, such as a computer, or a special purpose device, such as a client, a server, etc. Any of these general or special purpose devices can include any suitable components such as a hardware processor (which can be a microprocessor, a digital signal processor, a controller, etc.), memory, communication interfaces, display controllers, input devices, etc. For example, computing device 110 can be implemented as a personal computer, a laptop computer, a smartphone, a wearable computer, a tablet computer, a gaming device, a server, etc., or any suitable combination thereof.

Communications network 106 can be any suitable computer network or combination of such networks including the Internet, an intranet, a wide-area network (WAN), a local-area network (LAN), a wireless network, a digital subscriber line (DSL) network, a frame relay network, an asynchronous transfer mode (ATM) network, a virtual private network (VPN), etc. Communications links 104 and 108 can be any communications links suitable for communicating data among computing devices 110 and server 102, such as network links, dial-up links, wireless links, hard-wired links, any other suitable communications links, or any suitable combination of such links. Computing devices 110 and server 102 can be located at any suitable location.

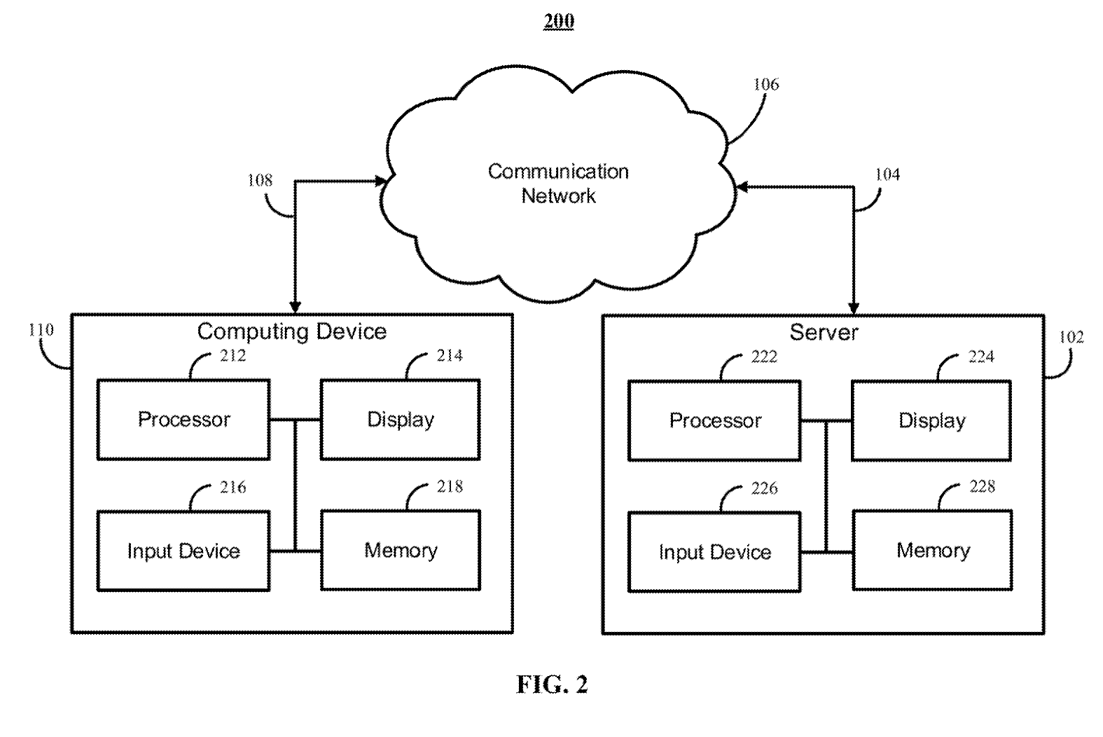

FIG. 2 illustrates an example 200 of hardware that can be used to implement server 102 and one of the computing devices 110 depicted in FIG. 1 in accordance with some embodiments of the disclosed subject matter. Referring to FIG. 2, computing device 110 can include a hardware processor 212, a display 214, an input device 216, and memory 218, which can be interconnected. In some embodiments, memory 218 can include a storage device (such as a non-transitory computer-readable medium) for storing a computer program for controlling hardware processor 212.

Hardware processor 212 can use the computer program to execute the mechanisms described herein, including: receiving data of a document to be presented, generating instructions to present the document on display 214, generating a summary for the document, adding one or more sentences of the document to the summary, sending and/or receiving data through communications link 108, and/or performing any other suitable actions. Display 214 can be a flat panel display (e.g., an LED display, an OLED display, a plasma display, etc.), a cathode ray tube display, a projector, a touchscreen, a speaker(s), and/or any other suitable display and/or presentation devices. Input device 216 can be a computer keyboard, a computer mouse, a microphone, a touchpad, a voice recognition circuit, a touchscreen, and/or any other suitable input device.

Server 102 can include a hardware processor 222, a display 224, an input device 226, and memory 228, which can be interconnected. In some embodiments, memory 228 can include a storage device for storing data received through communications link 104 or through other links. The storage device can further include a server program for controlling hardware processor 222.

Hardware processor 222 can use the server program to communicate with computing devices 110, as well as to provide access to and/or copies of the mechanisms described herein. Display 224 can be a flat panel display, a cathode ray tube display, a projector, a touchscreen, a speaker(s), and/or any other suitable display and/or presentation devices. Input device 226 can be a computer keyboard, a computer mouse, a touchpad, a voice recognition circuit, a touchscreen, and/or any other suitable input device.

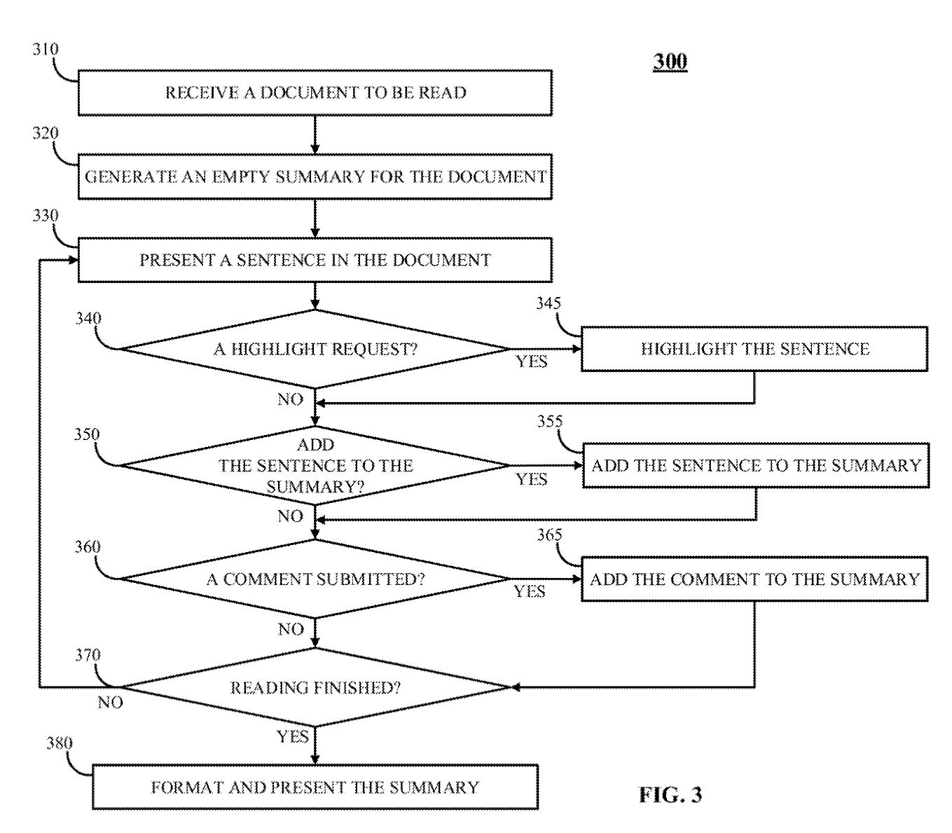

FIG. 3 shows an example 300 of a process for generating a summary of a document in accordance with some embodiments of the disclosed subject matter. In some embodiments, process 300 can be implemented by one or more hardware processors, such as one or more hardware processors of a computing device 110 and/or a server 102 as described above in connection with FIG. 1.

In some embodiments, process 300 can be executed as a part of an application for generating a summary of a document and can be used whenever a document is being presenting using the application. In some embodiments, process 300 can be executed as a plug-in, add-on, extension, or other additional software that can act in concert with other software, such MICROSOFT WORD, ADOBE READER, ADOBE ACROBAT, MOZILLA FIREFOX Web browser, GOOGLE CHROME Web browser, or any other document editing and/or reading software.

As illustrated, process 300 can begin by receiving a document to be read by a user at 310. In some embodiments, a document to be read can be received using any suitable technique(s). For example, in response to a user selection, process 300 can receive a document to be read from a user's library or a public library that is contained in an application executing process 300. As another example, process 300 can receive a document to be read based on a user selection of a document from a website when an application executing process 300 is running. As yet another example, when process 300 is executed as a plug-in, add-on, extension, or as any other software that can act in concert with another software, process 300 can receive a document to be read based on a user selection of a document using the other software.

In some embodiments, a document to be read can be received from a user's library and/or a public library. Such a user's library and/or a public library can contain documents that are imported from or opened from another application, purchased through an application executing process 300, etc. As described below, such a user's library and/or a public library can be organized and/or searched using any suitable technique.

In some embodiments, any suitable document can be imported into an application executing process 300. In such embodiments, documents can be imported form any suitable source, such as: DROPBOX; GOOGLE DRIVE; BOX; SKYDRIVE; SUGARSYNC; WEBDAV-SERVER; SFTP; OFFICE 365 SHAREPOINT; MYDISK.SE; FILESANYWHERE; STOREGATE; CLOUDME; a Web page or Web site; READ IT LATER; EVERNOTE; SHELFARI; INSTAPAPER; REEDER; an RSS feed; an email server (e.g., the application can be assigned an email address to which documents to be added to the library can be sent); etc.

In some embodiments, a document to be read can be in any suitable format and can include text, formatting information (e.g., different fonts, line spacing, bolding, italics, margins, etc.), images, video, and any other suitable information. Examples of document formats that can be used by process 300 can include: Portable Document Format (PDF) format; a plain text format such as ASCII, UTF-8, etc.; Amiga Guide format; Microsoft Word format (e.g., using file extension “.doc”); DjVu format; Office Open XML format (e.g., using file extension “.docx”); Open Document format (e.g., using file extension “.odt”); Open XML Paper Specification (OXPS) format; DocBook format (e.g., an XML format typically used for technical documentation); HTML (e.g., using extension “.html” or “.htm”); FictionBook format (e.g., using file extension “.fb2”); Pages Postscript format (e.g., using file extension “.ps”); Rich Text Format (RTF); TeX format; TEI format; Troff format; Uniform Office Format (e.g., a standard Chinese format); WordPerfect format (e.g., using file extension “.wpd,” “.wp,” “.wp7,” etc.); electronic publication (EPUB) format; AZW format; KF8 format; or any other suitable format or combination of formats.

At 320, process 300 can generate an empty summary for the received document. In some embodiments, the empty summary can include any suitable information relating to the received document. For example, the empty summary can include a name and/or title of the received document. As another example, the empty summary can include time and/or date information that indicates when the empty summary is being generated. As yet another example, if a received document contains multiple chapters and/or sections, titles and/or subtitles of the chapters and/or sections can be included in the empty summary. As still another example, if a received document is imported from a Web page, the generated empty summary can include any suitable information that indicates the original source of the received document, such as a Uniform resource locator (URL), a barcode (e.g., a quick response (QR) code), and/or any other suitable mechanism directed to the Web page.

In some embodiments, prior to generating an empty summary for the received document, the mechanisms can provide the user with an opportunity to provide consent to generate a summary for the received document. Additionally or alternatively, process 300 can provide a user interface (such as a settings menu) to prompt the user to turn on or turn off an option that corresponds to generating a summary for the received document. In some embodiments, in response to detecting one or more existing summaries that are related to the received document, process 300 can provide a user interface (such as a pop-up window) to prompt the user to select one or more suitable options, such as generating a new summary, presenting one of the existing summaries, editing one of the existing summaries, and/or any other suitable actions.

At 330, process 300 can present a sentence in the document. In some embodiments, process 300 can present the sentence in the document in any suitable manner. For example, in some cases, process 300 can present the sentences of the document one by one successively as a scrolling presentation at a certain reading speed. As another example, process 300 can present a portion of the document that contains the sentence. In such an example, the sentence can be presented in a special way (e.g., with a special font, with a special font-size, with a special font color, with a special background color, with a special light, etc.) compared to other sentences in order to prompt the user to read the sentence. As yet another example, process 300 can present a portion of the sentence in a special way compared to the remaining portions of the sentence in order to prompt the user to read that specific portion of the sentence.

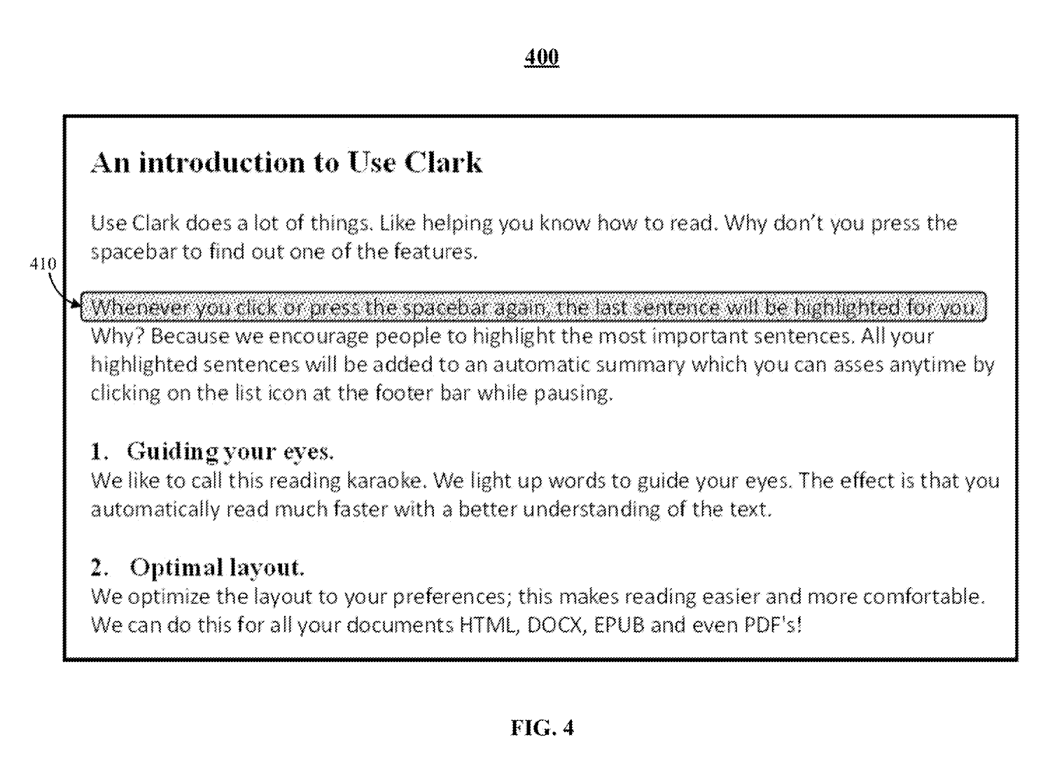

In a particular example, as illustrated in FIG. 4, a part of a document can be presented in a user interface 400 in which a sentence or a portion of a sentence can be emphasized in a grey bar 410. Grey bar 410 can move from one sentence, or one portion of a sentence, to the next sentence, or the next portion of the sentence, at a predetermined reading speed, which can guide the eyes of a user.

Referring back to FIG. 1, at 340, process 300 can determine whether a highlight request has been received. In some embodiments, a highlight request can correspond to any suitable user input (e.g., a gesture command, a voice command, a user selection of a highlighting button, etc.), and can be received using any suitable device (e.g., a touchscreen, a microphone, a gesture recognition system, a remote control, etc.). For example, in cases where an application executing process 300 is running on a computer device 110 having a touchscreen, a wipe gesture (e.g., using a finger, a stylus, or the like) from the left to the right over a sentence can indicate a highlight request for highlighting the sentence. As another example, a highlight request can be caused by a clicking and/or dragging operation performed with a pointing device coupled to a computing device 110.

In some embodiments, a highlight request can be triggered by another user request. For example, in some cases where sentences of the document are presented one by one successively as a scrolling presentation at a certain reading speed, a highlight request can be triggered by a pause request (e.g., pressing an ENTER key of a keyboard, clicking a pause button, etc.) from a user for pausing the scrolling presentation. In such an example, process 300 can cause the sentence being presented to be highlighted in response to receiving the pause request from the user. As another example, in connection with FIG. 4, when grey bar 410 is moving from one sentence, or one portion of a sentence, to the next sentence, or the next portion of the sentence, at a predetermined reading speed, process 300 can allow a user to pause the moving grey bar 410 for highlighting the sentence that is currently presented with grey bar 410.

If process 300 determines that a highlight request has been received (“YES” at 340), process 300 can highlight the sentence or a corresponding portion of the sentence at 345 using any suitable technique(s) to make the sentence or the corresponding portion of the sentence prominent to the user. For example, a sentence or a portion of a sentence can be highlighted in a bright color such as the yellow of a marker used for highlighting printed text. As another example, a sentence or a portion of a sentence can be highlighted by being associated with a sign such as an underline. As yet another example, a sentence or a portion of a sentence can be highlighted by being presented in a special font and/or special font size.

After highlighting the sentence or a portion of the sentence at 345, or, if a highlight request has not been received (“NO” at 340), process 300 can proceed to 350.

At 350, process 300 can determine if the sentence is to be added to the summary. Any suitable technique(s) and/or factor(s) can be used to make the determination. In some embodiments, process 300 can determine if the sentence is to be added to the summary based on a formatting analysis of the sentence. For example, if the sentence plays an important role in the structure of the document (e.g., a title or a subtitle of the document, a title or a subtitle of a section and/or a chapter of the document, an abstract sentence of the document, a conclusion sentence of a section and/or a chapter of the document, etc.), process 300 can determine that the sentence is to be added to the summary. As another example, if a portion of the sentence is emphasized, such as containing one or more bolded words, italic words, underlined words, capital written words, highlighted words, and/or any other suitable emphasized words, process 300 can determine that the sentence is to be added to the summary. As yet another example, if the sentence is associated with an image, a graph, a table, and/or an enumeration list of the document, process 300 can determine that the sentence is to be added to the summary.

In some embodiments, process 300 can determine if the sentence is to be added to the summary based on a words analysis of the sentence. For example, if the sentence contains a word that is a noun or a number, process 300 can determine that the sentence is to be added to the summary.

As another example, if the sentence contains a word within a signal words list, process 300 can determine that the sentence is to be added to the summary. In such an example, the signal words list can include any suitable words. In some embodiments, the signal words list can include any suitable signal words and/or phrases that indicate a conclusion, such as “consequently,” “finally,” “therefore,” “as a result,” “above all,” “in summary,” etc. In some embodiments, the signal words list can include any suitable signal words and/or phrases that indicate emphasis, such as “important,” “significant,” “especially,” “essential,” “key point,” “remember that,” “major development,” “a primary concern,” etc. In some embodiments, a signal words list can be determined using any suitable technique(s). For instance, a signal words list can be pre-determined by a user in a settings portion of an application executing process 300. As another instance, a signal words list can be determined and/or modified using one or more machine learning techniques.

As still another example, if the sentence contains a word that relates to one or more keywords within the document, process 300 can determine that the sentence is to be added to the summary. In such an example, a word related to a keyword can be a synonym word of a keyword, a hypernym word of a keyword, a hyponym word of a keyword, one of the words that describe a keyword, and/or a word that has any suitable relationship with the keyword. In some embodiments, one or more keywords of the document can be determined by any suitable technique(s). For example, one or more words that relate to the title, the subtitle, the abstract sentence(s), and/or the conclusion sentence(s) of the document can be determined to be the keywords of the documents. As another example, one or more keywords can be determined based on statistical information of the words in the document.

In some embodiments, process 300 can determine if the sentence is to be added to the summary based on additional information of the sentence. For example, if the sentence or a portion of the sentence has been highlighted at 345, process 300 can determine that the sentence is to be added to the summary. As another example, if the sentence or a portion of the sentence has been highlighted and/or bookmarked more than N (a pre-determined number) times by other readers, process 300 can determine that the sentence is to be added to the summary.

In some embodiments, one or more factors described above can be numerically scored and/or weighted using any suitable scale, and the resulting weighted scores can be combined in any suitable way to determine if the sentence is to be added to the summary. In some embodiments, a settings portion of an application executing process 300 can provide user selectable options corresponding to one or more factors to choose whether to consider the one or more factors when process 300 is making the determination.

In response to determining that the sentence is to be added to the summary (“YES” at 350), process 300 can add the sentence to the summary at 355. In some embodiments, process can mark the sentence (e.g., highlight the sentence, present the sentence in a pre-determined format, associate the sentence with an icon, etc.) if the sentence has been added to the summary. After adding the sentence to the summary, or, if the sentence is not to be added to the summary (“NO” at 350), process 300 can proceed to 360.

At 360, process 300 can determine if a comment associated with the sentence has been submitted from a user. In some embodiments, a comment can include any suitable information relating to the sentence and can be presented using any suitable media content, such as text, images, audio, video, and/or any other suitable content.

In response to determining that a comment associated with the sentence has been submitted (“YES” at 360), process 300 can add the comment to the summary at 365. After adding the comment to the summary, or, if there is no submitted comment associated with the sentence (“NO” at 360), process 300 can proceed to 370.

At 370, process 300 can determine if the reading of the document has been finished. In some embodiments, any suitable technique(s) and/or factor(s) can be used to make the determination. For example, if the document is being presented sentence by sentence successively in a scrolling way and at a certain reading speed, process 300 can determine that the reading of the document has been finished when the last sentence of the document has been presented. As another example, as shown in connection with FIG. 4, in cases in which a grey bar 410 is moving from one sentence, or one portion of a sentence, to the next sentence, or the next portion of the sentence, at a predetermined reading speed, process 300 can determine that the reading of the document has finished when grey bar 410 has reached the end of the document. As yet another example, process 300 can determine that the reading of the document has been finished based on a user input (e.g., a gesture command, a voice command, a user selection of a stop or close button, etc.) that indicates the user has finished reading the document.

In response to determining that the reading of the document has not finished (“NO” at 370), process 300 can return to 330 and continue presenting of the next sentence in the document. Otherwise, if the reading of the document has been finished (“YES” at 370), process 300 can proceed to 380.

At 380, process 300 can format the generated summary for presentation to the user, and cause the formatted summary to be presented to the user. The summary can be formatted using any suitable technique(s). For example, process 300 can format the summary based on a size and/or resolution of a display on which the summary is to be presented (e.g., the summary can be formatted such that a user does not have to scroll to read a single line of text, for example by changing a size of the summary, changing a font-size of the summary, changing line breaks in the summary, etc.).

As another example, process 300 can format the summary using predetermined formatting rules that promote faster reading speed, increased reading comprehension, increased concentration, and/or increased reading comfort of user. In such an example, predetermined formatting rules can include setting a font of the document to a particular font (e.g., to Arial, or any other suitable font), setting the size of the font to a particular size (e.g., 12 point font), setting the line spacing to a particular line spacing (e.g., 1.5 spacing), setting a text color to a particular text color (e.g., black), setting the background color of the document to a particular background color (e.g., light grey), adding extra space after each paragraph, breaking the text into two columns, and/or any other suitable formatting.

As yet another example, process 300 can format the summary based on software and/or hardware of a device executing process 300 such that the summary can be displayed to a user. For example, the summary can be formatted such that it is caused to be presented by the device (e.g., a desktop computer) executing process 300 so that it is presented in a proper way as the summary would be presented on another device (e.g., a smart phone) having a different hardware and/or software configuration.

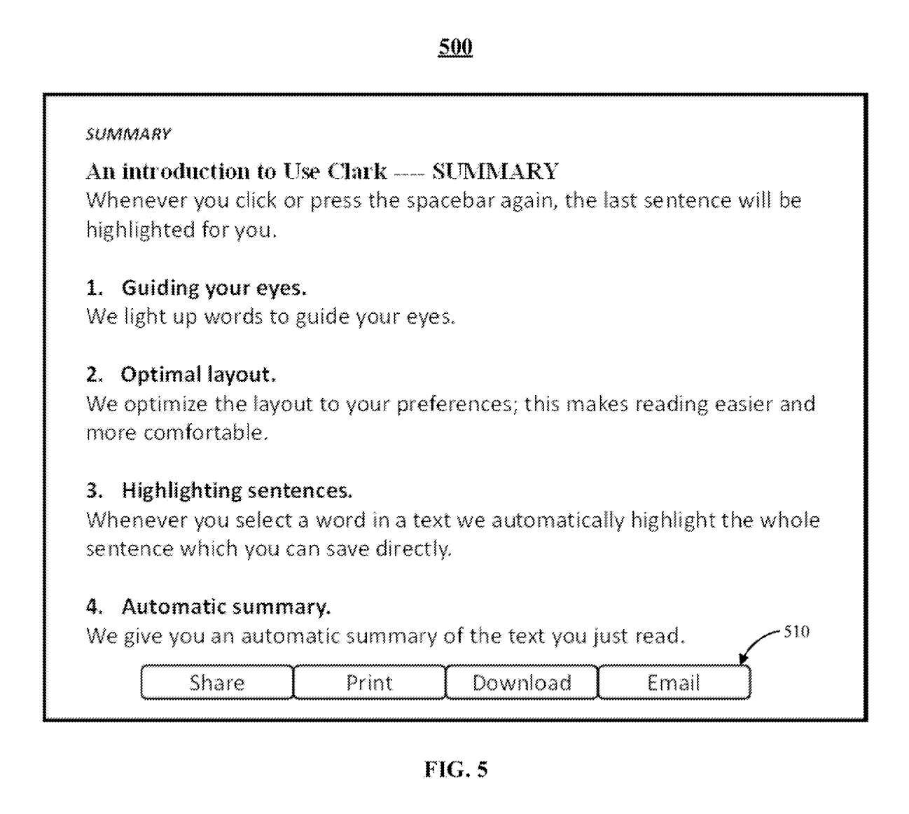

In a particular example, as illustrated in FIG. 5, a user interface 500 can present the generated summary of the document to the user. In some embodiments, user interface 500 can present the summary with any suitable information. For example, user interface 500 can present the summary with one or more headers and/or footers that indicate additional information of the summary such as a document number of the summary, a page member of the summary, time and/or date information that indicates when the summary was generated, etc. As another example, user interface 500 can present the summary with a URL and/or a barcode that indicate the original source of the received document. As yet another example, user interface 500 can present the summary with a tool bar 510 that contains one or more user interface elements which allow a user to perform various actions related to the summary.

In some embodiments, process 300 can initiate various actions related to the summary in response to receiving a user request, such as saving the summary as a separate document to a particular location (e.g., to a user's library of an application executing process 300, to a memory of a device, etc.), sharing the summary (e.g., using social media, email, text message, cloud storage, etc.), and/or printing the summary using any suitable printer, etc.

In some embodiment, process 300 can provide the user with an option to select to make the generated summary private or public. In response to receiving consent or authorization from the user to share the summary, process 300 can store the summary to a public library of an application executing process 300, and can enable the summary to be shown in a search function.

In some embodiments, process 300 can provide a search function for a user's library and/or a public library of an application executing process 300, which can use keywords to find summaries relating to documents in the user's and/or public library. In some embodiments, a user's library and/or a public library can be synchronized across multiple applications that use the mechanisms described herein (e.g., using the Internet, a local area network (LAN), etc.), and the generated summaries and/or documents can be saved with the user's and/or public library, such that the user can access any summaries and/or any documents, start reading a summary and/or a document on one device, and continue reading on a different device.

In some embodiments, the mechanisms described herein can include server-side software, client-side software, server-side hardware, client-side hardware, firmware, or any suitable combination thereof. For example, these mechanisms can encompass one or more Web pages or Web page portions (e.g., via any suitable encoding, such as Hyper Text Markup Language (“HTML”), Dynamic Hyper Text Markup Language (“DHTML”), Extensible Markup Language (“XML”), JavaServer Pages (“JSP”), Active Server Pages (“ASP”), Cold Fusion, or any other suitable approaches). As another example, these mechanisms can encompass a computer program that causes a processor to execute the user input interface application. For instance, these mechanisms can encompass a computer program written in a programming language recognizable by computing device 110 and/or server 102 that is executing the mechanisms (e.g., a program written in a programming language, such as, Java, C, Objective-C, C++, C#, JavaScript, Visual Basic, HTML, XML, Cold Fusion, any other suitable approaches, or any suitable combination thereof).

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that the above described steps of the process of FIG. 3 can be executed or performed in any order or sequence not limited to the order and sequence shown and described in the figure. Also, some of the above steps of the process of FIG. 3 can be executed or performed substantially simultaneously where appropriate, or in parallel, to reduce latency and processing times. Furthermore, it should be noted that FIG. 3 is provided as an example only. At least some of the steps shown in the figure may be performed in a different order than represented, performed concurrently, or omitted.

It should also be noted that, as used herein, the term mechanism can encompass hardware, software, firmware, or any suitable combination thereof. The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects. It should also be noted that, as used herein, the term mechanism can encompass hardware, software, firmware, or any suitable combination thereof.

Accordingly, methods, systems, and media for generating a summary of a document are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

1. A method for generating a summary of a document, the method comprising:
receiving a document to be read;
generating a summary of the document using a hardware processor;
presenting a plurality of sentences of the document at a set reading speed;
receiving a user request to pause the presentation of a sentence of the plurality of sentences; and
in response to the user request to pause the presentation of the sentence of the plurality of sentences:
highlighting a portion of the sentence within the plurality of sentences and
adding the sentence to the summary.

2. The method of claim 1, further comprising:
determining whether the sentence is to be added to the summary; and
adding the sentence to the summary based on the determination.

3. The method of claim 2, further comprising highlighting the sentence based on the determination.

4. The method of claim 2, wherein determining whether the sentence to be added to the summary is based on word analysis of the sentence.

5. The method of claim 2, wherein determining whether the sentence to be added to the summary is based on formatting analysis of the sentence.

6. The method of claim 1, wherein the user request is at least one of:
one mouse click; and
one touch on a touchscreen.

7. The method of claim 1, further comprising sharing the summary to a public library.

8. A system for generating a summary of a document, the system comprising:
a hardware processor that is programmed to:
receive a document to be read;
generate a summary of the document using a hardware processor;
present a plurality of sentences of the document at a set reading speed;
receive a user request to pause the presentation of a sentence of the plurality of sentences; and
in response to the user request to pause the presentation of the sentence of the plurality of sentences:
highlight a portion of the sentence within the plurality of sentences; and
add the sentence to the summary.

9. The system of claim 8, wherein the hardware processor is further programmed to:
determine whether the sentence is to be added to the summary; and
add the sentence to the summary based on the determination.

10. The system of claim 9, wherein the hardware processor is further programmed to highlight the sentence based on the determination.

11. The system of claim 9, wherein determining whether the sentence to be added to the summary is based on word analysis of the sentence.

12. The system of claim 9, wherein determining whether the sentence to be added to the summary is based on formatting analysis of the sentence.

13. The system of claim 8, wherein the user request is at least one of:
one mouse click; and
one touch on a touchscreen.

14. The system of claim 8, wherein the hardware processor is further programmed to share the summary to a public library.

15. A non-transitory computer-readable medium containing computer-executable instructions that, when executed by a processor, cause the processor to perform a method for generating a summary of a document, the method comprising:
receiving a document to be read;
generating a summary of the document using a hardware processor;
presenting a plurality of sentences of the document at a set reading speed;
receiving a user request to pause the presentation of a sentence of the plurality of sentences; and
in response to the user request to pause the presentation of the sentence of the plurality of sentences:
highlighting a portion of the sentence within the plurality of sentences; and
adding the sentence to the summary.

16. The non-transitory computer-readable medium of claim 15, wherein the method further comprises:
determining whether the sentence is to be added to the summary; and
adding the sentence to the summary based on the determination.

17. The non-transitory computer-readable medium of claim 16, wherein the method further comprises highlighting the sentence based on the determination.

18. The non-transitory computer-readable medium of claim 16, wherein determining whether the sentence to be added to the summary is based on word analysis of the sentence.

19. The non-transitory computer-readable medium of claim 16, wherein determining whether the sentence to be added to the summary is based on formatting analysis of the sentence.

20. The non-transitory computer-readable medium of claim 15, wherein the user request is at least one of:
one mouse click; and
one touch on a touchscreen.

21. The non-transitory computer-readable medium of claim 15, wherein the method further comprises sharing the summary to a public library.
